(19) United States
(12) Patent Application Publication
(10) Pub. No.: US 2007/0238324 A1
(43) Pub. Date: Oct. 11, 2007

(54) Electrical connector

(75) Inventor: Der-Yu Ho, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Lotes Co., Ltd.

(21) Appl. No.: 11/399,351

(22) Filed: Apr. 7, 2006

(51) Int. Cl. H01R 12/00

(52) U.S. Cl. 439/66

(57) ABSTRACT

An electrical connector for connection between two electronic devices by means of compressive contact is disclosed to include an electrically insulative connector body, which has a plurality of through holes cut through the top and bottom surfaces thereof, a plurality of conductors respectively formed on the top and bottom surface of the electrically insulative body, and a connection structure, which is formed of a conducting material covered on the surface of each of the through holes to electrically connect the conductors on the top surface of the electrically insulative connector body to the conductors on the bottom surface of the electrically insulative connector body respectively.

### BACKGROUND OF THE INVENTION

1. Field of the Invention

The present invention relates to electrical connectors and more particularly, to such an electrical connector, which eliminates the use of terminals.

2. Description of the Related Art

Following fast development of computer technology, computer component parts such as CPUs (Central Processing Unit), chip modules and computer connectors are made having a complicated architecture and a relatively stronger function. In consequence, the requirements for precision and reliability on the connection between devices are critical. In order to match the performance of a CPU, chip module, or circuit board, the terminals of an electrical connector are commonly formed of an array of pins. Therefore, BGA (Ball Grid Array) bonding technique is commonly employed to electrical connectors. However, the manufacturing process of a BGA design electrical connector is complicated, resulting in a high manufacturing cost. BGA (Ball Grid Array) is a bonding technology commonly employed to the manufacturing of electrical connectors. However, a BGA type electrical connector has the disadvantages of high CPU, chip module and circuit board bonding cost and complicated manufacturing process. Because of a high bonding height, a BGA type electrical connector requires much installation space. In order to reduce installation space, LGP (Land Grid Package) is introduced. However, either BGA or LGP packaging technology, terminals (metal contact pins) must be used in the connector for the contact of the CPU, chip module, or circuit board. The use of the terminals (metal contact pins) greatly complicates the manufacturing procedure, resulting in a high manufacturing cost.

U.S. Pat. No. 5,071,359 discloses a BGA or LGP connector related technique, entitled “Array Connector”, filed on Apr. 27, 1990, issued on Dec. 10, 1991. According to this design, the connector has a preformed elastomeric sheet-form member 20 provided with a series of apertures 22 through each of which an electrically conductive plated metal deposit extends. An integral end 24 of the deposits protrudes outwardly beyond a surface of the sheet-form member 20, forming contact surfaces for demateably engaging the pads. However, it is not easy to keep the integral end of the deposits in positive contact with the solder balls.

Therefore, it is desirable to provide an electrical connector that eliminates the drawbacks of the aforesaid prior art design.

### SUMMARY OF THE INVENTION

The present invention has been accomplished under the circumstances in view. It is the main object of the present invention to provide an electrical connector, which eliminates installation of terminals on the electrically insulative connector body.

To achieve this and other objects of the present invention, the electrical connector comprises an electrically insulative connector body, which has a plurality of through holes cut through the top and bottom surfaces thereof, a plurality of conductors respectively formed on the top and bottom surface of the electrically insulative body, and a connection structure, which is formed of a conducting material covered on the surface of each of the through holes to electrically connect the conductors on the top surface of the electrically insulative connector body to the conductors on the bottom surface of the electrically insulative connector body respectively. The electrical connector allows connection between two external electronic devices by means of compressive contact. Because the electrical connector eliminates installation of terminals and uses the conductors and the connection structure as substitutes, the invention greatly simplifies electrical connector manufacturing process and lowers electrical connector manufacturing cost.

### BRIEF DESCRIPTION OF THE DRAWINGS

FIG. 1 is an elevational view of a part of an electrical connector in accordance with a first embodiment of the present invention.

FIG. 2 is a sectional elevation of a part of the electrical connector in accordance with the first embodiment of the present invention.

FIG. 3 is an enlarged view of a part of FIG. 2.

FIG. 4 is a schematic top view showing the whole architecture of the electrical connector in accordance with the first embodiment of the present invention.

FIG. 5 is a schematic drawing showing the electrical connector of the first embodiment of the present invention fastened to a chip module.

FIG. 6 is a perspective view of an electrical connector in accordance with a second embodiment of the present invention.

FIG. 7 is an enlarged view of a part of FIG. 6.

FIG. 8 is a perspective view of an electrical connector in accordance with a third embodiment of the present invention.

FIG. 9 is a sectional elevation of the electrical connector in accordance with the third embodiment of the present invention.

FIG. 10 is an enlarged view of a part of FIG. 8.

FIG. 11 is an enlarged view of a part of FIG. 9.

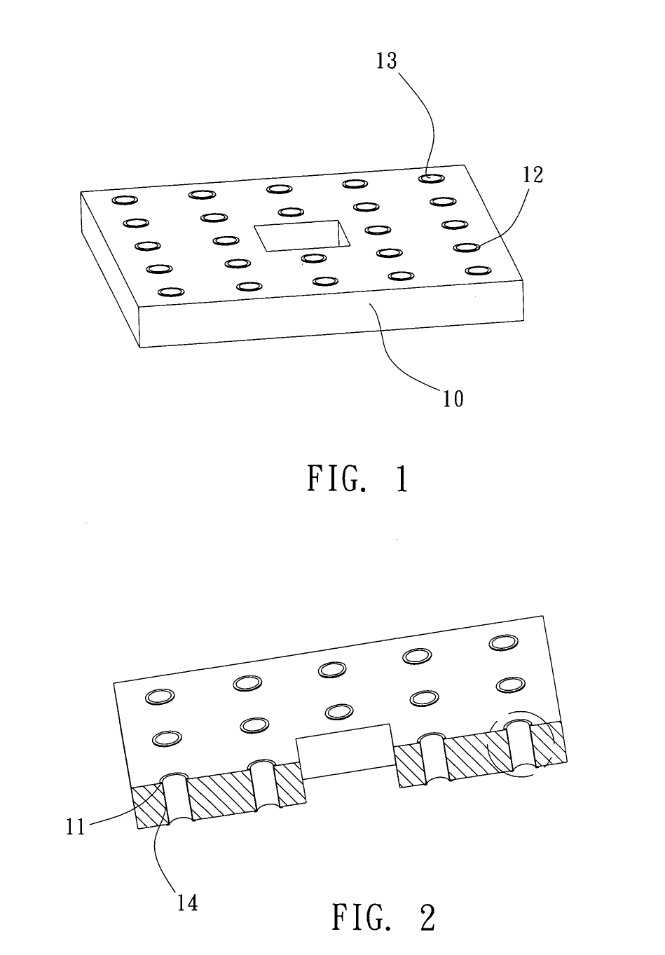

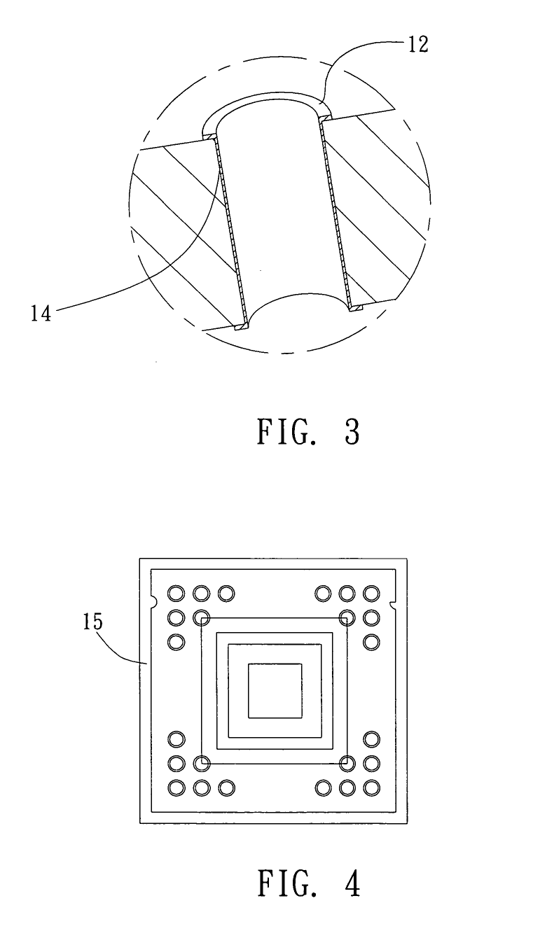

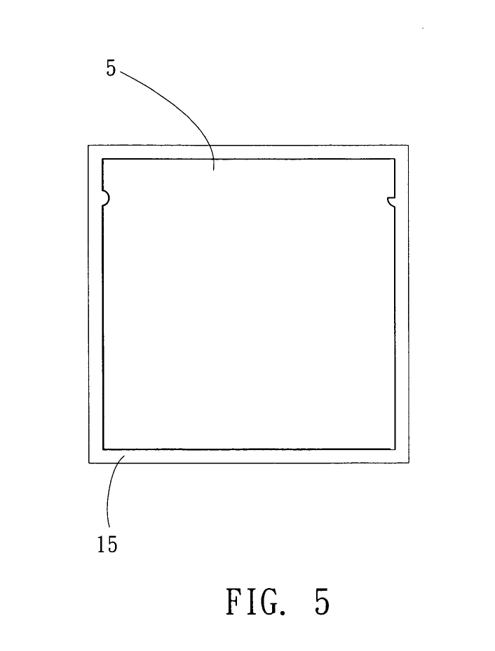

### DETAILED DESCRIPTION OF THE INVENTION

Referring to FIGS. 1˜5, an electrical connector in accordance with the present invention is adapted to connect two electronic devices electrically. According to this embodiment, the electrical connector is adapted to connect a chip module 5 to a circuit board (not shown). Alternatively, the electrical connector can be used for connection between two circuit boards, or other two electronic devices. In one application example of the present invention, the two sides of the electrical connector are respectively connected to a respective electronic device by means of compressive contact. In another application example, one side of the electrical connector is connected to a first electronic device by means of compressive contact while the other side of the electrical connector is soldered to a second electronic device. The electrical connector in accordance with a first embodiment of the present invention as shown in FIGS. 1˜5 is comprised of an electrically insulative connector body 10, and a plurality of conductors 11 and a connection structure mounted in the electrically insulative connector body 10.

The electrically insulative connector body 10 is preferably made of an elastic material. Alternatively, the electrically insulative connector body 10 can be made of a non-elastic material. In this case, the conductors 11 are resilient, assuring effective contact of the electrical connector with the external device. The electrically insulative connector body 10 has a peripheral frame wall 15, which works as locating means connectable to the chip module 5.

The conductors 11 are directly and symmetrically printed on the top and bottom surfaces of the electrically insulative connector body 10 at predetermined locations, each having an annular contact portion 12. Further, through holes 14 are formed on the electrically insulative connector body 10 and respectively cut through the top and bottom surfaces of the electrically insulative connector body 10 between the annular contact portions 12 of the conductors 11 at the top surface of the electrically insulative connector body 10 and the annular contact portions 12 of the conductors 11 at the bottom surface of the electrically insulative connector body 10. The surface of each through hole 13 is coated with a layer of conducting material 14. The conducting material 14 forms the aforesaid connection structure that connects the annular contact portions 12 of the conductors 11 at the top surface of the electrically insulative connector body 10 and the annular contact portions 12 of the conductors 11 at the bottom surface of the electrically insulative connector body 10 respectively.

Therefore, by means of the conductors 12 and the conducting material 14, the electrical connector of the present invention is electrically connectable between two external electronic devices (for example, a chip module and a circuit board). The conductors 12 and the conducting material 14 can be simultaneously formed on the electrically insulative connector body 10 by electroplating.

Because the electrical connector of the present invention uses the conductors 12 and the connection structure (the conducting material 14) to substitute for terminals (metal contact pins), the invention eliminates a terminal processing process, thereby simplifying the manufacturing process and effectively lowering the manufacturing cost.

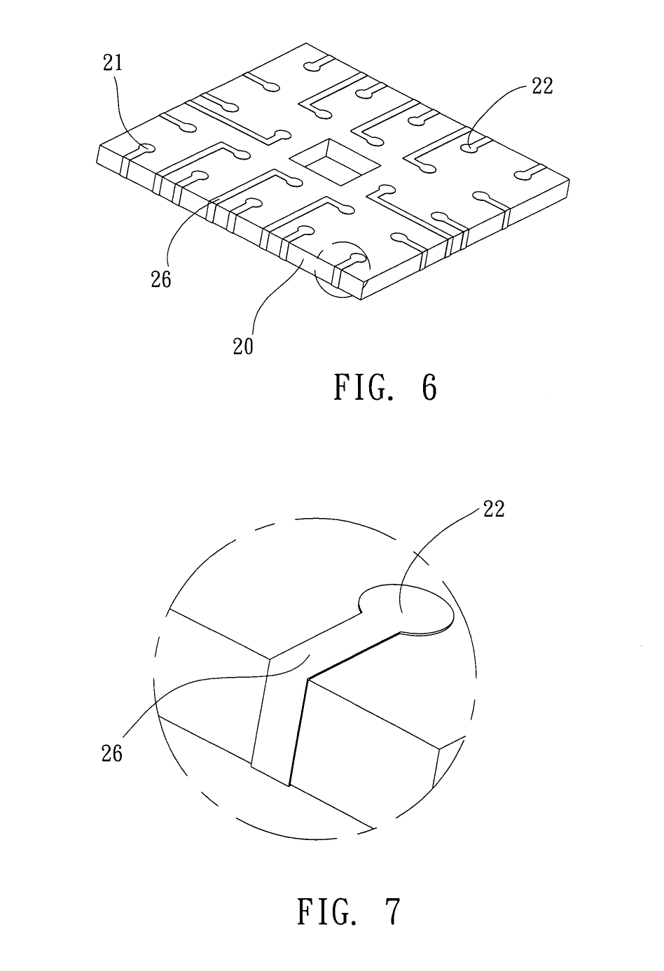

FIGS. 6 and 7 show an electrical connector in accordance with a second embodiment of the present invention. According to this embodiment, the conductors 21 are respectively printed on the top and bottom surfaces of the electrically insulative connector body 10 at predetermined locations, each having a circular contact portion 22; the connection structure is comprised of a plurality of conducting wires 26 extending from the top surface of the electrically insulative connector body 10 to the bottom surface of the electrically insulative connector body 10 and respectively connected to the circular contact portions 22 of the conductors 21 at the top surface of the electrically insulative connector body 10 and the circular contact portions 22 of the conductors 21 at the bottom surface of the electrically insulative connector body 10. By means of the conductors 21 and the conducting wires 26, the electrical connector of this second embodiment is electrically connectable between two external electronic devices, i.e., the electrical connector of this second embodiment achieves the same effect as the aforesaid first embodiment of the present invention.

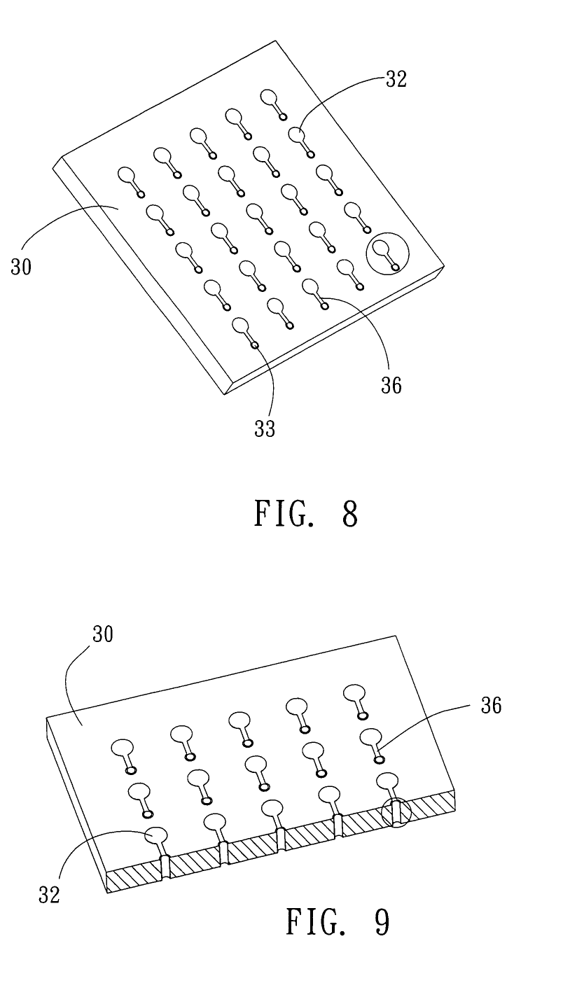

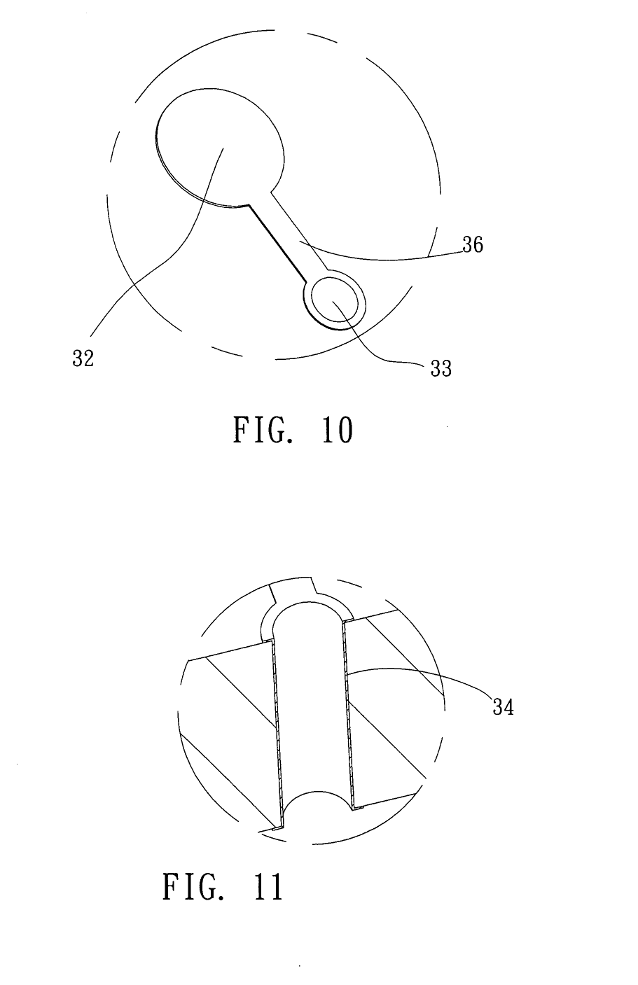

FIGS. 8˜11 show an electrical connector in accordance with a third embodiment of the present invention. According to this embodiment, the electrical connector is comprised of an electrically insulative connector body 30, which has a plurality of through holes 33 cut through the top and bottom surfaces thereof, a plurality of conductors 31 respectively symmetrically formed on the top and bottom surfaces of the electrically insulative connector body 30 and each having a circular contact portion 32, a conducting material 34 formed on the surface of each through hole 33, and a plurality of conducting wires 36 respectively connected between the conducting material 34 and the circular contact portions 32 of the conductors 31. According to this embodiment, the conducting material 34 is electroplated on the surface of each of the through holes 33, and the conducting wires 36 are formed on the electrically insulative connector body 30 by printing.

A prototype of electrical connector has been constructed with the features of FIGS. 1˜11. The electrical connector functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. An electrical connector comprising:
an electrically insulative body, said electrically insulative body having a first surface and a second surface opposite to said first surface;
a plurality of conductors symmetrically formed on the first surface and second surface of said electrically insulative body, said conductors each having an annular contact portion; and
at least one conducting wire connected to the annular contact portions of said conductors, wherein said electrically insulative connector body is an elastic member.

2. The electrical connector as claimed in claim 1, wherein said at least one conducting wire each extends from the annular contact portion of one of said conductors on said first surface to the annular contact portion of one of said conductors on said second surface.

3. The electrical connector as claimed in claim 1, wherein said conductors are printed on said electrically insulative connector body.

4. The electrical connector as claimed in claim 1, wherein said conductors and said conducting wires are electroplated on said electrically insulative connector body.

5. The electrical connector as claimed in claim 1, wherein the top and bottom surfaces of said electrically insulative connector body are respectively connected to a respective electronic device by means of compressive contact.

6. (canceled)

7. The electrical connector as claimed in claim 1, further comprising a locating means connectable to an external electronic device.

8. The electrical connector as claimed in claim 7, wherein said locating means is a fixed peripheral frame wall extending around said electrically insulative connector body.

9. An electrical connector comprising:
an electrically insulative connector body, said electrically insulative connector body having a first surface and a second surface opposite to said first surface, at least one of said first surface and said second surface being connected to an external electronic device by means of compressive contact;
a plurality of conductors respectively disposed at the top surface and bottom surface of said electrically insulative connector body; and
a connection structure mounted in said electrically insulative connector body to connect said conductors electrically, wherein said electrically insulative connector body is an elastic member.

10. The electrical connector as claimed in claim 9, wherein said conductors each have an annular contact portion.

11. The electrical connector as claimed in claim 10, wherein said electrically insulative connector body has a plurality of through holes cut through the top surface and bottom surface thereof and respectively connected between the conductors at the top surface of said electrically insulative connector body and the conductors at the bottom surface of said electrically insulative connector body.

12. The electrical connector as claimed in claim 9, wherein said conductors each have a circular contact portion.

13. The electrical connector as claimed in claim 12, wherein said electrically insulative connector body has a plurality of through holes cut through the top surface and bottom surface thereof; said connection structure comprises a conducting material formed on the surface of each of said through holes and a plurality of conducting wires respectively connected between the conducting material on the surface of each of said through holes and the circular contact portion of each of said conductors.

14. The electrical connector as claimed in claim 9, wherein said conductors are printed on said electrically insulative connector body.

15. The electrical connector as claimed in claim 9, wherein said conductors and said connection structure are electroplated on said electrically insulative connector body.

16. The electrical connector as claimed in claim 9, wherein the top surface and bottom surface of said electrically insulative connector body are respectively connected to a respective external electronic device by means of compressive contact.

17. (canceled)

18. The electrical connector as claimed in claim 9, further comprising a locating means connectable to an external electronic device.

19. The electrical connector as claimed in claim 18, wherein said locating means is a fixed peripheral frame wall extending around said electrically insulative connector body.
